(19) United States
(12) Patent Application Publication
(10) Pub. No.: US 2014/0372506 A1
(43) Pub. Date: Dec. 18, 2014

(54) MANAGING AND USING REMOTE APPLICATIONS ON A MOBILE DEVICE

(71) Applicant: Microsoft Corporation, Redmond, WA (US)

(72) Inventors: Christopher R. Butner, Seattle, WA (US); Debaprajna Bhattacharyya, Redmond, WA (US); Rishad Madhura Kuzhiyil, Redmond, WA (US); Elton Saul, Woodinville, WA (US); David Bélanger, Carnation, WA (US)

(21) Appl. No.: 13/917,458

(22) Filed: Jun. 13, 2013

(51) Int. Cl. H04L 29/08

(52) U.S. Cl. CPC H04L 67/04
USPC 709/203

(57) ABSTRACT

Embodiments are directed to implementing remote applications, switching between remote applications provided by different remote application servers and to presenting application notifications across remote application servers. In one scenario, a client computer system sends, to a remote application server, an indication that a remote desktop application is to be launched. It then receives, from the remote application server, window state information for various remote applications provided by the remote desktop application. The client computer system filters the received window state information to determine which remote application windows are to be displayed on the client computer system, and aggregates window state information from the filtered remote application windows that are to be displayed on the client computer system to determine which category each remote application window is to be placed in. The client computer system then displays the determined remote application windows.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed for remote processing. Such applications are typically known as remote desktop applications, or simply remote applications. These remote applications are hosted by one or more host server computer systems. The server hosts instantiate and run the remote applications, while select portions of the application data are transferred to the user's computer system. The user's computer system, or client system, interprets the incoming data and displays the remote application data received from the server. In this manner, the user can initiate and interact with the remote application on their computer system, while the majority of the application processing is performed by the host server.

### BRIEF SUMMARY

Embodiments described herein are directed to implementing remote applications, switching between remote applications provided by different remote application servers and to presenting application notifications across remote application servers. In one embodiment, a client computer system sends, to a remote application server, an indication that a remote desktop application is to be launched on the remote application server and displayed on the client computer system. It then receives, from the remote application server, window state information for various remote applications provided by the remote desktop application, including existing windows for applications that were previously instantiated. The client computer system filters the received window state information to determine which remote application windows are to be displayed on the client computer system, and aggregates window state information from the filtered remote application windows that are to be displayed on the client computer system to determine which category each remote application window is to be placed in. The client computer system then displays the determined remote application windows.

In another embodiment, a computer system allows switching between remote applications provided by different remote application servers. The computer system determines that a first remote application is being provided by a first remote application server, and that a second remote application is being provided by a second, different application server. The computer system filters window state information for both the first remote application and the second remote application to determine which remote application windows from each remote application server are to be displayed on the computer system. It then aggregates window state information from the filtered remote application windows to determine how the remote application windows are to be categorized, receives a user input indicating that focus is to be changed from the first remote application to the second remote application, and displays the second remote application in the foreground of the computer system, according to categories as indicated by the aggregated window state information.

In yet another embodiment, a computer system presents application notifications across remote application servers. The computer system aggregates state data including window state, filter state and/or aggregated state, from remote application servers that are configured to provide remote applications. The computer system determines that a change has occurred in the window state, filter state and/or aggregated state, where the change meets a threshold level of significance. The computer system generates a notification that indicates the change that occurred in relation to the remote application(s) and displays the generated notification.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including implementing remote applications.

FIG. 2 illustrates a flowchart of an example method for implementing remote applications.

FIG. 3 illustrates a flowchart of an example method for switching between remote applications provided by different remote application servers.

FIG. 4 illustrates a flowchart of an example method for presenting application notifications across remote application servers.

FIG. 5 illustrates an embodiment in which a computer architecture in which embodiments described herein may operate including switching between remote applications provided by different remote application servers.

FIG. 6 illustrates an example embodiment of a session selection bar.

### DETAILED DESCRIPTION

Embodiments described herein are directed to implementing remote applications, switching between remote applications provided by different remote application servers and to presenting application notifications across remote application servers. In one embodiment, a client computer system sends, to a remote application server, an indication that a remote desktop application is to be launched on the remote application server and displayed on the client computer system. It then receives, from the remote application server, window state information for various remote applications provided by the remote desktop application, including existing windows for applications that were previously instantiated. The client computer system filters the received window state information to determine which remote application windows are to be displayed on the client computer system, and aggregates window state information from the filtered remote application windows that are to be displayed on the client computer system to determine which category each remote application window is to be placed in. The client computer system then displays the determined remote application windows.

In another embodiment, a computer system allows switching between remote applications provided by different remote application servers. The computer system determines that a first remote application is being provided by a first remote application server, and that a second remote application is being provided by a second, different application server. The computer system filters window state information for both the first remote application and the second remote application to determine which remote application windows from each remote application server are to be displayed on the computer system. It then aggregates window state information from the filtered remote application windows to determine how the remote application windows are to be categorized, receives a user input indicating that focus is to be changed from the first remote application to the second remote application, and displays the second remote application in the foreground of the computer system, according to categories as indicated by the aggregated window state information.

In yet another embodiment, a computer system presents application notifications across remote application servers. The computer system aggregates state data including window state, filter state and/or aggregated state, from remote application servers that are configured to provide remote applications. The computer system determines that a change has occurred in the window state, filter state and/or aggregated state, where the change meets a threshold level of significance. The computer system generates a notification that indicates the change that occurred in relation to the remote application(s) and displays the generated notification.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

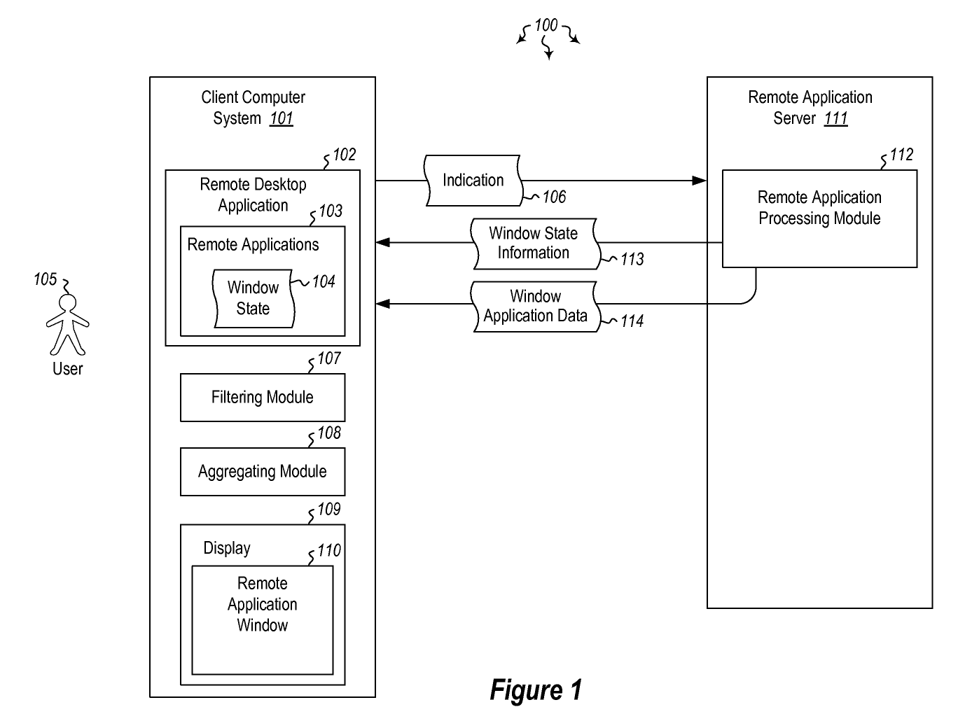

FIG. 1 illustrates a computer architecture 100 in which at least one embodiment may be employed. Computer architecture 100 includes client computer system 101. Client computer system 101 may be any type of local or distributed computer system, including a cloud computing system. The client computer system includes various modules for performing a variety of different functions. For instance, client computer system 101 includes a filtering module 107. The filtering module may filter window state information 113 received from the remote application server 111. This window state information may be sent to the client computer system in response to the client computer system sending an indication 106 (on behalf of user 105, for example) that a remote application is to be launched. In some embodiments, for example, the user may open a remote desktop application 102 that allows various remote applications 103 to be launched. Each remote application has its own window state 104 indicating various properties of the remote application's display window. When multiple applications are open, the applications may be in various states. This window state information 113 may thus be filtered by filtering module 107.

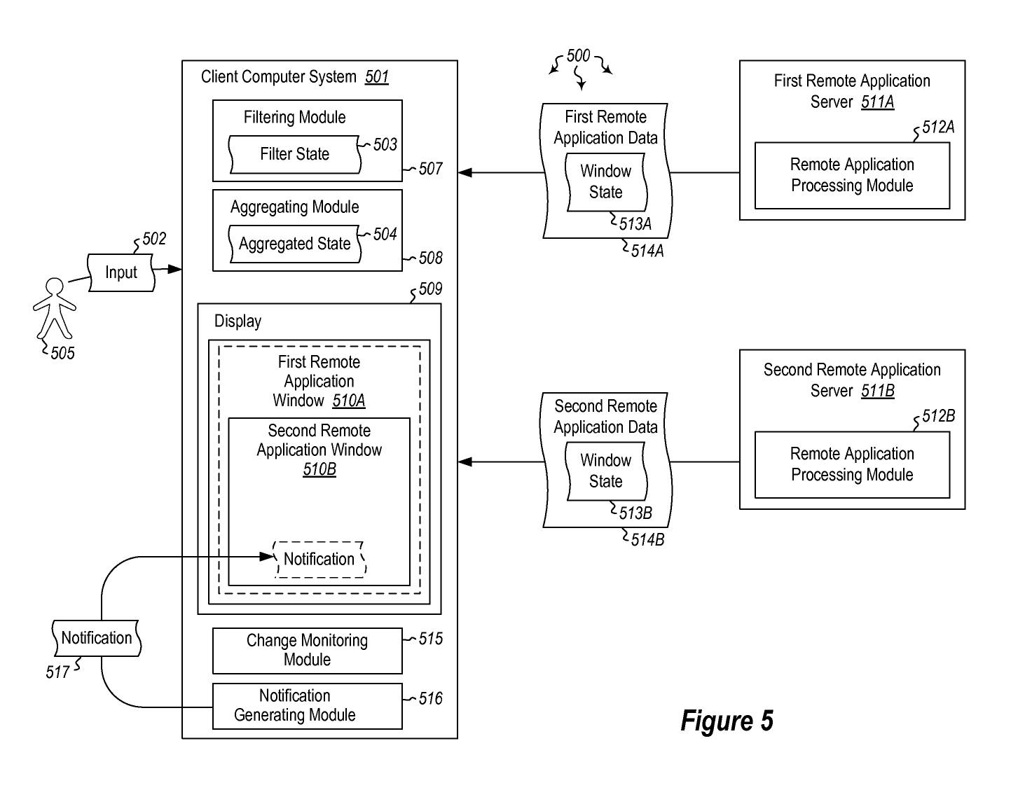

The filtering module 107 may make (or assist in making) determinations as to which applications are to be displayed. As will be explained further below with regard to FIG. 5, the user 105 may be able to switch between remote applications 103. When the user switches from one remote application to another application, the window 110 of the second remote application will be displayed over that of the first window, and will receive focus for receiving user inputs. In some cases, an aggregating module 108 may be used to determine whether remote applications belong in certain categories, and may then place those applications in the determined categories. The client computing system 101 may then receive and process remote application data 114 from the remote application processing module 112 to display the windows for the various remote applications. Accordingly, the client computer system 101 may be configured to perform a wide range of functionality, including the functionality described below.

Embodiments described herein may be configured to hook or capture characteristics of, and updates to, remote application windows on a remote application server (e.g. 111), including the windows' geometry, styles, window hierarchy, window grouping, decoration, chrome, state, IDs and graphics content, and may further relay these to the client computer system 101. The client computer system 101 may hook or capture user inputs and relay these to the appropriate window on remote application server 111, taking into account the current client-side device context and the user's choice of window arrangement. In some cases, the client-side device context may include portions of client-side and/or server-side information, including which of multiple different servers is currently active. The client computer system 101 may also receive user input at the remote application window 110 and convert the inputs into a consistent aggregate proxy state, and further send appropriate commands to the remote application server.

As mentioned above, the filtering module 107 may filter client-side remote application windows using window state information 113 into various categories, including: windows that a user should see in a list and be able to switch between, windows that a user should see and interact with directly, but not switch to using a list, windows that should be grouped together in a list because of their server-side application affiliation, and windows that should be grouped together in a list because of their origin (e.g. created through user interactions, or launched by another application or window without direct user interaction). The aggregating module 108 may aggregate the window state 113 for multiple windows in a filtered category to determine various properties of a category, including: aggregate category title, icon, or UI presentation style, primary or representative window for a category or last-shown or interacted-with window for a category.

This window, graphical, input, filtered and/or aggregate state may then be used to: a) display window graphics to the user, without using proxy windows in a client-side windowing system, such that one app is useable at any time, maximizing the use of available screen area and optimizing for touch control, b) as with (a), but displaying window graphics such that multiple windows are usable either in sequence, or simultaneously, c) accept user input for (a) or (b) via touch, mouse, pen or keyboard method, such that input is targeted to a particular app or window, d) accept user input in one form (e.g. touch), that is designed to relay input in another form (e.g. mouse or keyboard), to the remote application server 111, or e) use gestures, toggles or complex calculation of user intent to disambiguate and choose between multiple (c) or (d) sub-modes. For example, the window or other state may be used in determining whether a swipe should be sent to a remote server, should trigger a switch between remote applications, or pan a client-side view (depending on a toggled mode), or speed or targeting of the interaction.

The window, graphical, input, filtered and/or aggregate state may further be used to show complementary user interface components on the client-side device to allow user 105 to: see an overview of window and window aggregation information, including title, icon, thumbnail preview, switch between windows (even when those windows are not currently visible in a graphical form to the user), switch between aggregations of windows, close windows, close aggregations of windows or perform other operations. For example, the window, graphical, input, filtered and/or aggregate state may be used to add automatic behaviors to the user experience, including: automatically maximizing apps and windows when switching into or launching apps or windows to maximize the use of available screen space, automatically minimizing and/or hiding applications and windows when switching away from apps or windows to give the feel of a single-application experience, automatically hiding minimized window graphics on the server side, automatically hiding minimized window graphics on the client-side device for servers that do not support hiding, and automatically deciding on the best user input scheme for the target server system. These and other functionality provided by the various state information will be described further below.

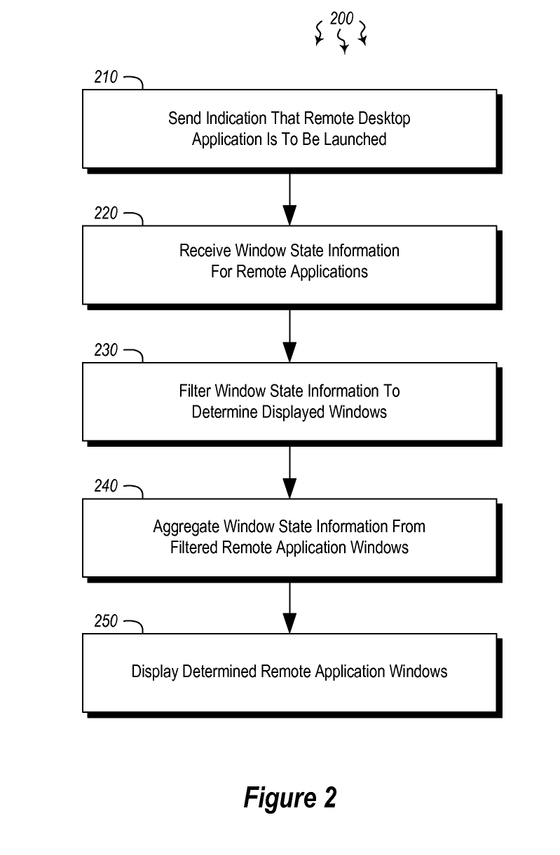

FIG. 5 illustrates a scenario where applications and windows are delivered from multiple remote servers (e.g. 511A and 511B) into a seamless control-system that facilitates (at least) the following: window filtering that can operate on sets of windows spanning multiple remote servers, window aggregation that can operate on filtered state spanning multiple remote servers, users can see and operate complementary user interface components with seamless views of window and window aggregation information that spans multiple remote servers, automatic behaviors that operate when launching, switching, or closing applications, and windows spanning multiple remote servers. The control system further notifies users of important changes in window, filtered and aggregate state spanning multiple remote servers. For instance, if a new email notification is presented to the user via a complementary user interface component, the notification would allow the user to switch into their email application, ignore the notification, or save the notification for later reference. These concepts will be explained further below with regard to methods 200, 300 and 400 of FIGS. 2, 3 and 4, respectively.

In view of the systems and architectures described above, methodologies that may be implemented in accordance with the disclosed subject matter will be better appreciated with reference to the flow charts of FIGS. 2, 3 and 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for implementing remote applications. The method 200 will now be described with frequent reference to the components and data of environment 100.

Method 200 includes an act of sending, to a remote application server, an indication that a remote desktop application is to be launched on the remote application server and displayed on the client computer system (act 210). For example, client computer system 101 may send indication 106 to remote application server 111 that indicates that remote application 103 is to be launched on the remote application server 111 and displayed on the client computer system 101. The remote application may be any type of software application or software functionality that is processed remotely by remote application server 111. The remote applications may include, for instance, word processing applications, spreadsheet applications, email and calendaring applications, internet applications or other types of applications. The client computer system 101 accepts different types of inputs to interact with these remote applications. The user inputs may include, for example, mouse, keyboard, pen, touch inputs, gestures, or other types of inputs. Moreover, if the remote application server 111 does not support a certain type of input (e.g. touch inputs), the client computer system 101 may convert or translate those (touch) inputs into a type of input (e.g. mouse or keyboard) that is understood by the remote application server.

Method 200 further includes an act of receiving, from the remote application server, window state information for one or more remote applications provided by the remote desktop application, including one or more existing windows for applications that were previously instantiated (act 220). The client computer system 101 may thus receive window state information 113 from the remote application server 111. The window state information may include window state for various remote applications 103 including existing remote applications that are already running on the client computer system. The window state may indicate, for example, which window is currently active. This may be determined based on context (e.g. the active application is the last one clicked, or the last one opened, etc.). In some cases, each of the remote application windows 110 may be treated as its own remote session. As such, the remote application window may allow users to interact with the entire remote session through the application window.

Next, method 200 includes an act of filtering the received window state information to determine which remote application windows are to be displayed on the client computer system; (act 230). The filtering module 107 filters the window state information 113 to determine which remote application windows 110 are to be displayed in display 109. In cases where the client computer system 101 is a tablet or mobile phone, the display may take up the entire screen. As such, if a remote application is to be shown on the display, it may be automatically maximized to fill the screen. In cases where applications are shown in a list (e.g. a list that shows all of the remote applications that are available to the user 105), the filtering module 107 may filter the application windows that belong in that list.

The aggregating module 108 may then aggregate window state information 113 from the filtered remote application windows that are to be displayed on the client computer system to determine which category each remote application window is to be placed in (act 240). The remote applications may be aggregated, for example, based on primary window for a specified group, or last interacted-with window for a group, or based on some other criteria. The determined remote application windows may then be displayed on display 109 (act 250). Each window may have its own presentation style or other settings applied to it. Moreover, each window may have its own representative icon, thumbnail or other image or graphic.

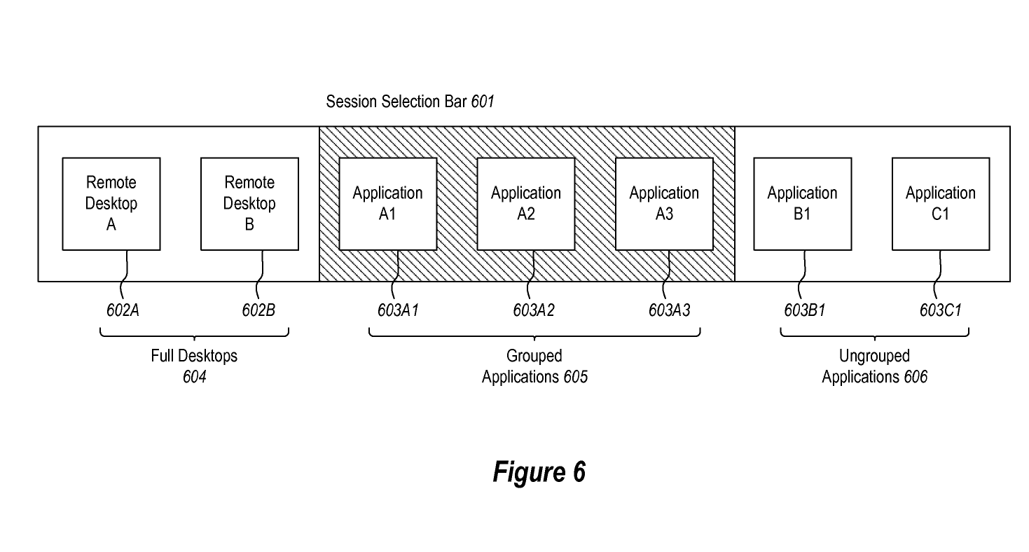

In some cases, displaying the determined remote application windows 110 includes showing remote desktop application graphics (i.e. the application graphics that are being sent from the remote application server) in the remote application windows. Additionally or alternatively, displaying the determined remote application windows 110 may include displaying remote desktop application graphics in a taskbar user interface, which may be used for switching applications and/or closing applications. For example, as shown in FIG. 6, a remote session may have a corresponding session selection bar 601. The session selection bar allows the user to select from different remote application windows 110 including those currently displayed in display 109. The session selection bar 601 may include full remote desktop sessions 604 (e.g. remote desktops 602A and 602B), grouped applications 605 (e.g. applications 603A1, 603A2 and 603A3) which are shown together with, perhaps a similar background color or image, and ungrouped applications 606 (e.g. application 603B1 and application 603B2). The user 105 can select any of these applications or desktops using any type of input such as mouse, keyboard, touch, gestures or other forms of input.

Thus, in cases where remote applications are grouped together according to category, the categorized, grouped applications may be shown as a group (e.g. 605). A user may thus be able to browse remote applications (or remote application windows) according to category, as determined by the aggregating module 108. The applications may be grouped based on substantially any type of category, including parent or child, active applications, last-interacted-with applications, etc. The session selection bar 601 (or other similar available application list) may allow the user 105 to launch remote applications, switch between remote applications and/or control applications using the client computing device 101. The remote application windows 110 may be kept active and shown in the sequence of last use. This allows the user to quickly switch between remote applications, even on a tablet or smart phone device. Still further, remote application window information 113 may be received from the remote application server 111 using a variety of different communication channels, including a remote application channel. As such, each remote application may be provided with a substantially full screen display.

The session selection bar 601 may integrate remote desktop sessions that are running on multiple servers, and may show multiple different remote application windows, potentially each from different remote servers. The tiles, icons or switch buttons may be updated periodically for each application window. In some cases, a group of windows may have a collective group aggregate tile/button with group title, group icon, switch button and/or close button. This group of windows may be expanded out of or collapsed into the display 109. Window and group tiles/buttons may also automatically flash, appear, twinkle or otherwise attract user attention to indicate that a “notification” has been received from a window that is not the current window. The notification may be from the current server, or from another server, but still shown on the session selection bar. Various schemes may exist for classification of notifications. For example, all (or some) windows that the client is notified of that the client has not yet seen may be classed as notifications.

In some embodiments, remote application publishing systems may be implemented such that users (e.g. 105) can launch and switch between applications published from a central source that is not the remote server 111 or the client device 101. In such situations, the client computer system 101 keeps a corresponding list of published remote apps in sync with the central source. Then, any applications launched or switched to in this manner may operate with the embodiments described above. In some cases, remote application windows may be filtered into a list that shows applications in a complementary user interface component. This may be implemented by checking window visibility, checking for presentation style or other settings and/or checking for window owner. The windows may then be grouped by checking a remote application identifier (ID), checking for a window owner and/or tree of ownership hierarchy. The aggregating module 108 may then generate aggregate information by choosing the first-seen window in a group that is in the “should show” list as the group's representative window, choosing a group's representative window's icon as the group's icon, or choosing a group's representative window's title as the group's title. Other options are also available for generating aggregate information.

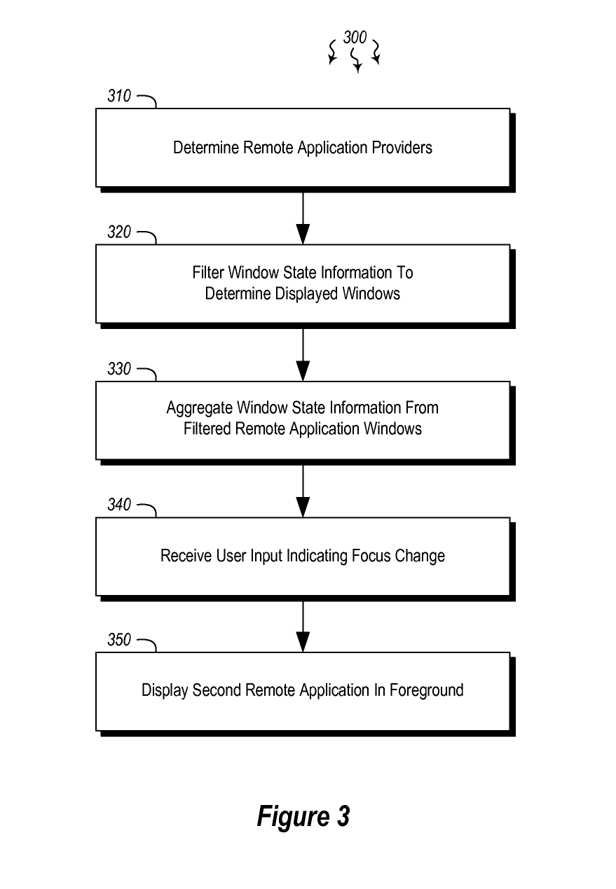

The client computer system may further be configured to track the last activated window within each group, so that switching to a group can be performed in a single action, in addition to the option of switching into the user's choice of remote application window within a group. As mentioned above, remote application windows may be opened in full screen mode automatically, giving the user a “single-application” experience, while maintaining the flexibility to operate multiple applications or windows simultaneously. In some cases, application windows may be maximized as the client computer system 101 is notified of them. Other windows may be minimized when switching between applications or windows, or launching new applications. Users may thus check and act on each window individually. Minimized windows may be hidden on the remote application server side through configuration of a window manager. In some cases, minimized windows may be hidden on older servers that lack the appropriate configuration, by moving windows to a specific graphics coordinate (e.g. −32000,−32000) after they are minimized, ensuring no non-minimized windows are moved there through the use of a debounce and/or stability check. Switching between application windows will be explained further below with regard to FIG. 3.

FIG. 3 illustrates a flowchart of a method 300 for switching between remote applications provided by different remote application servers. The method 300 will now be described with frequent reference to the components and data of environment 500 of FIG. 5.

Method 300 includes an act of determining that a first remote application is being provided by a first remote application server, and that a second remote application is being provided by a second, different application server (act 310). For instance, first remote application server 511A may use remote application processing module 512A to produce and send first remote application data 514A, along with its corresponding window state information 513A. Similarly, second remote application server 511B may use remote application processing module 512B to produce and send second remote application data 514B, along with its corresponding window state information 513B. The filtering module 507 of client computer system 501 may then filter window state information for both the first remote application and the second remote application to determine which remote application windows (e.g. 510A and 510B) from each remote application server are to be displayed in display 509 (act 320). The aggregating module 508 may then aggregate window state information 513A/B from the filtered remote application windows to determine how the remote application windows are to be categorized (act 330).

Next, the client computer system 501 may receive a user input 502 from user 505 indicating that focus is to be changed from the first remote application to the second remote application (act 340). The second remote application may then be displayed in the foreground of display 509, according to categories as indicated by the aggregated window state information (act 350). The second remote application window 510B may be displayed on top of the first remote application window 510A, such that the first remote application window is no longer visible. Moreover, at least in some embodiments, the remote application window that currently has focus may cover all other applications, providing the user with a “single application” experience, where the user only sees the current application, even though other remote applications may also be running, and may be switched to at any time.

Still further, aggregation information may be displayed including titles, icons, thumbnails or other representative graphics for any of the remote applications, including the first and second remote applications. After a user has switched to another application, that application has focus to receive user inputs. If the application that was switched to allows inputs that are not supported by the server providing that application (e.g. second remote application server 511B), the inputs may be translated to inputs that are supported by that server. Moreover, when switching between remote applications, the application that is launched or switched to is automatically maximized, and is automatically minimized when the user switches to another application.

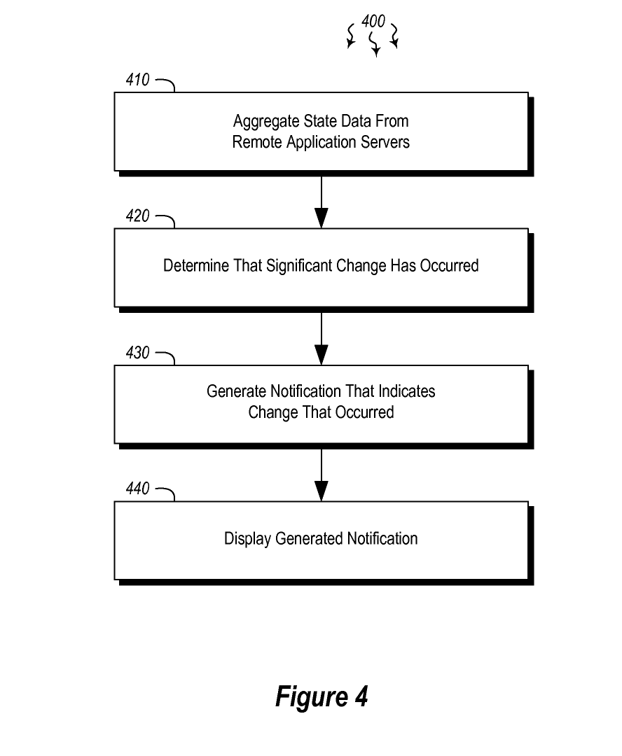

FIG. 4 illustrates a flowchart of a method 400 for presenting application notifications across remote application servers. The method 400 will now be described with frequent reference to the components and data of environment 500 of FIG. 5.

Method 400 includes an act of aggregating state data including at least one of window state, filter state and aggregated state, from a plurality of remote application servers configured to provide remote applications (act 410). The aggregating module 508 may aggregate state data including window state 513A, filter state 503 and/or aggregated state 504, from remote application servers 511A, 511B or other servers. The change monitoring module 515 may look at the various forms of state and determine that a change has occurred, where the change meets a threshold level of significance (act 420). Thus, for example, if the user 505 receives an email in an email application, or loses a connection in another application, or another application has a change significant enough to meet the threshold, the notification generating module 516 generates a notification 517 that indicates the change that occurred in relation to the one or more remote applications (act 430). These changes may occur even when the remote applications are minimized or are in the background. As such, the notification 517 may be displayed (act 440) as an overlay on top of the currently-active window. The generated notification may be displayed without switching focus to the remote application that triggered the notification.

In some cases, the notification may be sent to a notification system of the client computer system's operating system. The notifications may thus be integrated with the client computer system's own notification system. As such, the notifications may appear in the manner normally performed by the operating system's notification system. The notifications may be generated based on changes that occur on any type of state, regardless of where the remote application is hosted (e.g. on first remote application server 511A or second remote application server 511B. In some embodiments, the notification may include an option to switch to the remote application for which the notification was generated. This may be a link or button or other graphical user interface (GUI) element that take causes the application for which the notification was generated to be displayed. In some cases, the notification may attract attention to an existing UI, or it may create new, temporary UI. The temporary UI may be able to be “shelved” and saved for later by the user. And, as with the above notifications, the existing or temporary UI may allow the user to switch into the application window (regardless of server host) that caused the notification 517 to be generated.

Accordingly, methods, systems and computer program products are provided which implement remote applications. Moreover, methods, systems and computer program products are provided which switch between remote applications provided by different remote application servers, and present application notifications across remote application servers.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A client computer system comprising the following:
one or more processors;
system memory;
one or more computer-readable storage media having stored thereon computer-executable instructions that, when executed by the one or more processors, causes the client computing system to perform a method for implementing remote applications, the method comprising the following:
an act of sending, to a remote application server, an indication that a remote desktop application is to be launched on the remote application server and displayed on the client computer system;
an act of receiving, from the remote application server, window state information for one or more remote applications provided by the remote desktop application, including one or more existing windows for applications that were previously instantiated;
an act of filtering the received window state information to determine which remote application windows are to be displayed on the client computer system;
an act of aggregating window state information from the filtered remote application windows that are to be displayed on the client computer system to determine which category each remote application window is to be placed in; and
an act of displaying the determined remote application windows.

2. The client computer system of claim 1, wherein displaying the determined remote application windows comprises at least one of showing remote desktop application graphics in the remote application windows, and displaying remote desktop application graphics in a taskbar user interface.

3. The client computer system of claim 1, wherein the determined remote application windows are displayed according to category as determined by the aggregation.

4. The client computer system of claim 1, wherein the remote applications are at least one of automatically maximized upon launching and automatically minimized when switching from one remote application to another remote application.

5. The client computer system of claim 1, further comprising providing each remote application at least one of the following: an icon, a title and a thumbnail image.

6. The client computer system of claim 1, wherein the client computer system comprises a tablet computing device, and wherein the display allows users to perform at least one of the following: launch remote applications, switch between remote applications and control applications using the tablet computing device.

7. The client computer system of claim 1, wherein remote application window information is received from the remote application server using a remote application channel, such that each remote application is provided with a substantially full screen display.

8. The client computer system of claim 1, wherein the active remote application windows are shown in a taskbar UI.

9. The client computer system of claim 1, wherein the client computer system accepts as inputs any one or more of the following input types: mouse, keyboard, pen, touch and gestures, and further translates between input types prior to sending input data to the remote application server.

10. The client computer system of claim 1, wherein each of the remote application windows is treated as its own remote session, the remote application window allowing users to interact with the entire remote session.

11. The client computer system of claim 1, wherein the client computer system determines which remote application window is active based on context.

12. A computer system comprising the following:
one or more processors;
system memory;
one or more computer-readable storage media having stored thereon computer-executable instructions that, when executed by the one or more processors, causes the computing system to perform a method for switching between remote applications provided by different remote application servers, the method comprising the following:
an act of determining that a first remote application is being provided by a first remote application server, and that a second remote application is being provided by a second, different remote application server;
an act of filtering window state information for both the first remote application and the second remote application to determine which remote application windows from each remote application server are to be displayed on the computer system;
an act of aggregating window state information from the filtered remote application windows to determine how the remote application windows are to be categorized;
an act of receiving a user input indicating that focus is to be changed from the first remote application to the second remote application; and
an act of displaying the second remote application in the foreground of the computer system, according to categories as indicated by the aggregated window state information.

13. The computer system of claim 12, further comprising displaying aggregation information including at least one of the following: a title, an icon and a thumbnail of at least one of the first and second remote applications.

14. The computer system of claim 12, wherein the first remote application and the second remote application are provided by the same remote application server.

15. The computer system of claim 12, further comprising switching from an application window of the first remote application to an application window of the second remote application, such that the second remote application has focus to receive user inputs.

16. The computer system of claim 12, wherein the first remote application is automatically maximized upon launching and is automatically minimized when switching from the first application to another application.

17. A computer system comprising the following:
one or more processors;
system memory;
one or more computer-readable storage media having stored thereon computer-executable instructions that, when executed by the one or more processors, causes the computing system to perform a method for presenting application notifications across remote application servers, the method comprising the following:
an act of aggregating state data including at least one of window state, filter state and aggregated state, from a plurality of remote application servers configured to provide remote applications;
an act of determining that a change has occurred in at least one of window state, filter state and aggregated state, the change meeting a threshold level of significance;
an act of generating a notification that indicates the change that occurred in relation to the one or more remote applications; and
an act of displaying the generated notification.

18. The computer system of claim 17, wherein the generated notification is displayed without switching focus to the remote application that triggered the notification.

19. The computer system of claim 17, wherein the notification is sent to a notification system of the computer system's operating system, the notification system being configured to display the generated notification.

20. The computer system of claim 17, wherein the notification includes an option to switch to the remote application for which the notification was generated.
